(19) United States
(12) Patent Application Publication
(10) Pub. No.: US 2022/0212273 A1
(43) Pub. Date: Jul. 7, 2022

(54) CUTTER HOLDER ASSEMBLY CAPABLE OF PREVENTING A CUTTER THEREOF FROM FALLING

(71) Applicant: SHIN-YAIN INDUSTRIAL CO., LTD., Taichung City (TW)

(72) Inventor: PEN HUNG CHEN, TAICHUNG CITY (TW)

(21) Appl. No.: 17/143,312

(22) Filed: Jan. 7, 2021

(51) Int. Cl. B23B 51/12

(52) U.S. Cl. CPC B23B 51/12

(57) ABSTRACT

A cutter holder assembly capable of preventing a cutter thereof from falling includes a cutter holder, a cutter, a positioning key, a compressing element, and a nut. The cutter holder has a chamber and a mounting hole both formed in the cutter holder. The chamber has at least one engaging groove formed therein and having a guiding channel and a limiting groove communicating with each other. The cutter has a keyway formed thereon. The positioning key is mounted in the keyway and can extend into the guiding channel and the limiting groove, such that the positioning key can be limited in the cutter holder along with the cutter. The compressing element is mounted to the mounting hole and can move relative to the mounting hole to compress the positioning key in the limiting groove of the at least one engaging groove. The nut is sleeved on the cutter holder.

### BACKGROUND OF THE INVENTION

### 1. Field of the Invention

The present invention relates to a cutter holder assembly, and more particularly to a cutter holder assembly capable of preventing a cutter thereof from falling.

### 2. Description of Related Art

A conventional cutter holder assembly capable of preventing a cutter thereof from falling includes a side lock holder, a cutter, and a fixation element. The side lock holder has a mounting groove. The cutter has a compression groove disposed on an outer surface of the cutter. To fix the cutter in the side lock holder, extend the cutter into the side lock holder firstly, and then rotate the cutter to align the compression groove of the cutter with the mounting groove of the side lock holder. Next, insert the fixation element into the mounting groove of the side lock holder and make the fixation element abut against the compression groove of the cutter to fix the cutter in the side lock holder.

However, after the cutter is extended into the side lock holder, the compression groove of the cutter is shielded by the side lock holder, and a user cannot see the position of the compression groove of the cutter from an exterior of the side lock holder. The user needs to rotate the cutter repeatedly to align the compression groove of the cutter with the mounting groove of the side lock holder. Overall, the conventional cutter holder assembly capable of preventing a cutter thereof from falling has the disadvantages of taking too much time for the user to rotate the cutter to align the compression groove of the cutter with the mounting groove of the side lock holder and being inconvenient in installation.

To overcome the shortcomings of the conventional cutter holder assembly capable of preventing a cutter thereof from falling, the present invention tends to provide a cutter holder assembly capable of preventing a cutter thereof from falling to mitigate or obviate the aforementioned problems.

### SUMMARY OF THE INVENTION

The main objective of the present invention is to provide a cutter holder assembly capable of preventing a cutter thereof from falling.

The cutter holder assembly capable of preventing a cutter thereof from falling includes a cutter holder, an end cap, a cutter, a positioning key, a compressing element, and a nut. The cutter holder has a chamber and a mounting hole. The chamber is formed in the cutter holder and has at least one engaging groove. The at least one engaging groove is formed on an inner surface of the chamber and has a guiding channel and a limiting groove. The guiding channel is formed on the inner surface of the chamber and has a longitudinal direction. The limiting groove is formed on the inner surface of the chamber, communicates with the guiding channel, and has a longitudinal direction. An included angle is formed between the longitudinal direction of the limiting groove and the longitudinal direction of the guiding channel. The mounting hole is formed in the cutter holder and communicates with the chamber of the cutter holder.

The end cap is mounted on one of two end surfaces of the cutter holder adjacent to the chamber and has at least one guiding groove. The at least one guiding groove is formed on an inner surface of the end cap, is aligned with the guiding channel of the at least one engaging groove of the cutter holder, and communicates with the guiding channel. The cutter is inserted through the end cap, extends into the chamber of the cutter holder, and has a keyway formed on an outer surface of the cutter.

The positioning key is mounted in the keyway of the cutter and has a body and a protruding rod. The body is mounted in the keyway of the cutter. The protruding rod protrudes from one of two sides of the body away from the keyway of the cutter and is capable of extending into the guiding channel and the limiting groove of the at least one engaging groove, such that the positioning key is limited in the cutter holder along with the cutter. The compressing element is mounted to the mounting hole of the cutter holder and is capable of moving relative to the mounting hole along an axial direction of the cutter holder.

In such an arrangement, the compressing element abuts against one of two ends of the cutter inserted into the chamber of the cutter holder to tightly compress the protruding rod of the positioning key in the limiting groove of the at least one engaging groove. The nut is sleeved on the cutter holder and surrounds the chamber of the cutter holder. The positioning key is limited in the limiting groove of the at least one engaging groove of the cutter holder after the protruding rod of the positioning key is guided into the guiding channel and the limiting groove of the at least one engaging groove sequentially.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view in partial section of a cutter holder assembly capable of preventing a cutter thereof from falling in accordance with the present invention;

FIG. 2 is an exploded perspective view in partial section of the cutter holder assembly in FIG. 1;

FIG. 3 is a cross sectional side view of the cutter holder assembly in FIG. 1;

FIG. 4 is a perspective view in partial section of a cutter holder of the cutter holder assembly in FIG. 1;

FIG. 5 is a cross sectional side view of the cutter holder of the cutter holder assembly in FIG. 1;

FIG. 6 is a cross sectional end view of the cutter holder of the cutter holder assembly along line 6-6 in FIG. 5; and

FIGS. 7 to 10 are schematic views showing how the cutter holder assembly of the present invention is assembled.

### DETAILED DESCRIPTION OF THE PREFERRED EMBODIMENT

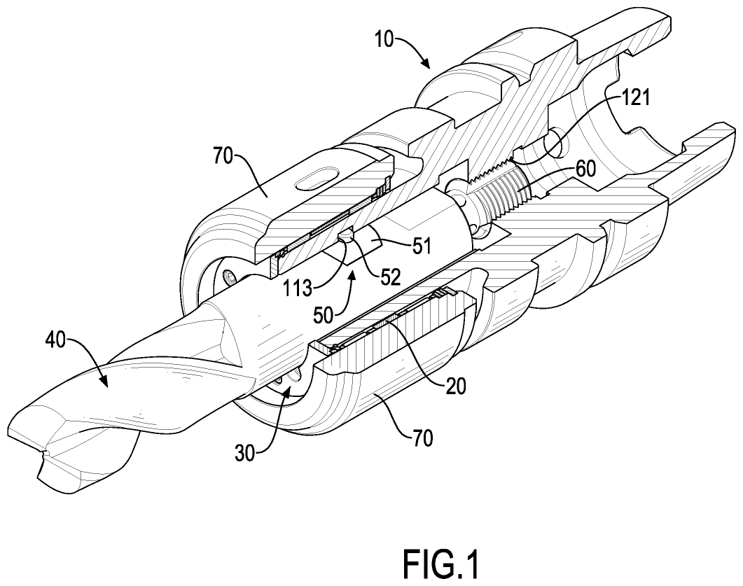

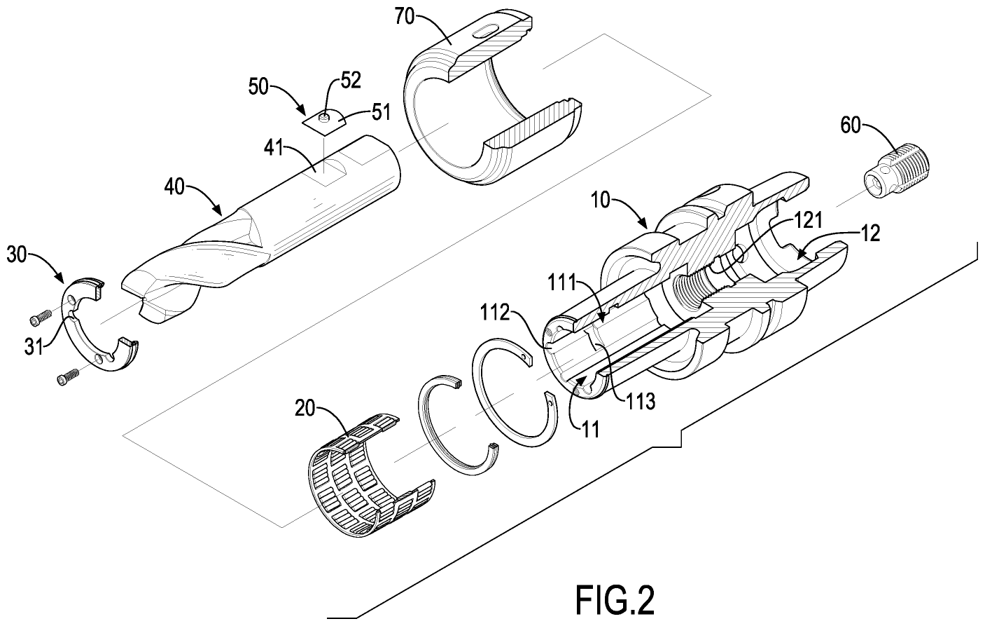

With reference to FIGS. 1 and 2, a cutter holder assembly capable of preventing a cutter thereof from falling in accordance with the present invention includes a cutter holder 10, a needle roller bearing 20, an end cap 30, a cutter 40, a positioning key 50, a compressing element 60, and a nut 70.

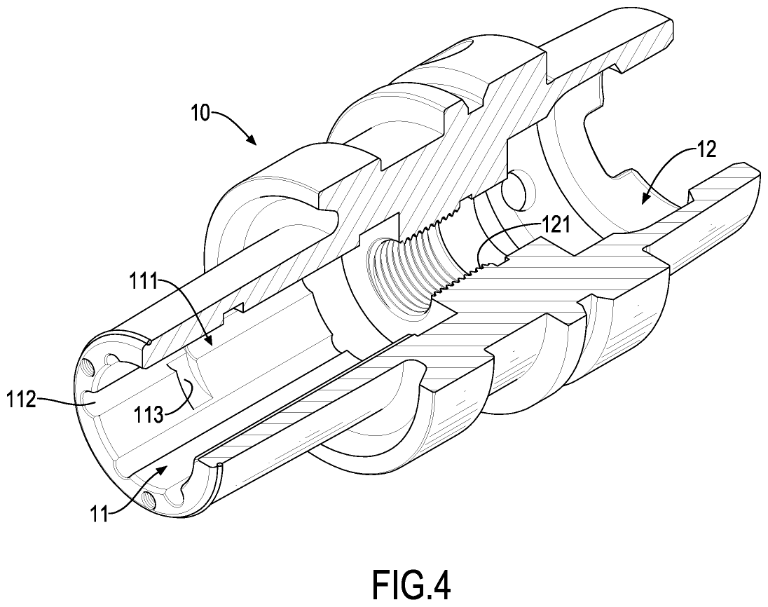

With reference to FIGS. 2, 4, and 5, the cutter holder 10 has a chamber 11 and a mounting groove 12. The chamber 11 is formed in the cutter holder 10 and has at least one engaging groove 111. The at least one engaging groove 111 is formed on an inner surface of the chamber 11, and has a guiding channel 112 and a limiting groove 113. The guiding channel 112 is formed on the inner surface of the chamber 11 and extends along an axial direction of the cutter holder 10. The limiting groove 113 is formed on the inner surface of the chamber 11 and communicates with the guiding channel 112. An included angle is formed between a longitudinal direction of the limiting groove 113 and a longitudinal direction of the guiding channel 112. In the present invention, the included angle is a right angle.

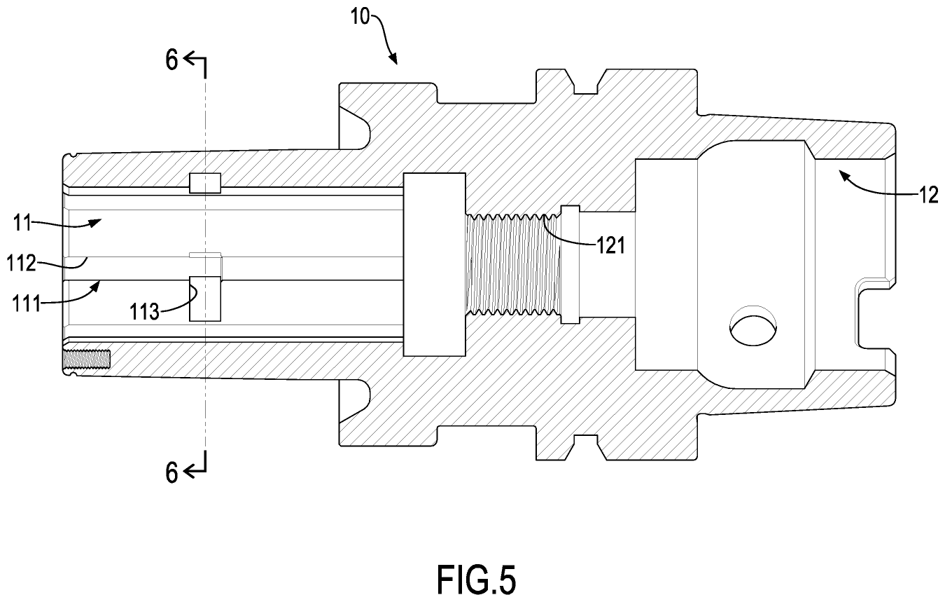

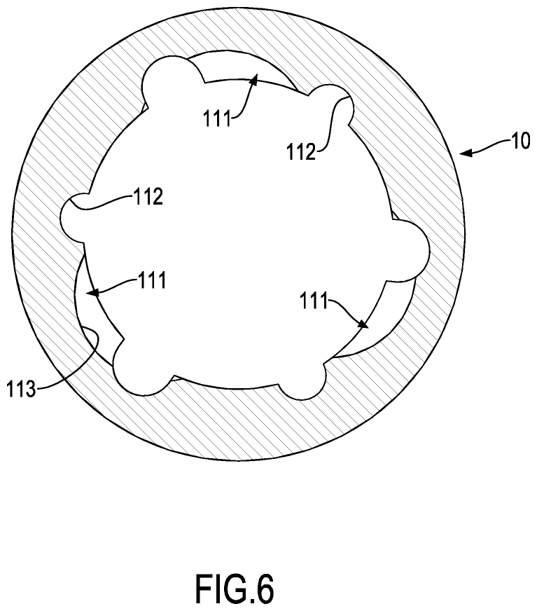

With reference to FIGS. 5 and 6, furthermore, the chamber 11 has three engaging grooves 111 on the inner surface of the chamber 11 at spaced intervals. The mounting groove 12 is formed in one of two ends of the cutter holder 10 opposite to the chamber 11, communicates with the chamber 11, and has a mounting hole 121 formed in one of two ends of the mounting groove 12 adjacent to the chamber 11 and communicating with the chamber 11. In the present invention, the mounting hole 121 is a threaded hole.

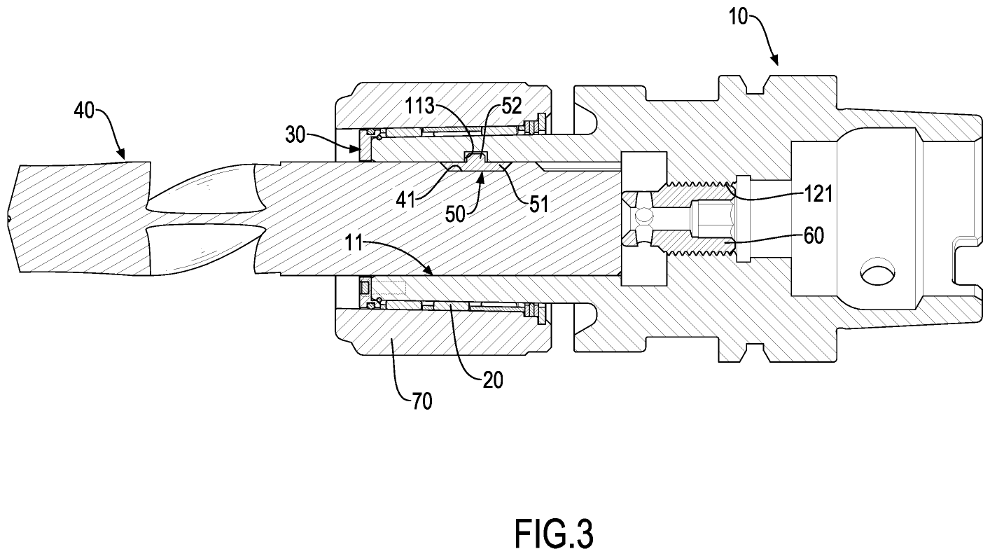

With reference to FIGS. 1 to 3, the needle roller bearing 20 is sleeved on an outer surface of the cutter holder 10 and surrounds the chamber 11.

With reference to FIGS. 2 to 4, the end cap 30 is fixed and mounted on one of two end surfaces of the cutter holder 10 adjacent to the chamber 11 and has at least one guiding groove 31. The at least one guiding groove 31 is formed on an inner surface of the end cap 30, is aligned with the guiding channel 112 of the at least one engaging groove 111 of the cutter holder 10, and communicates with the guiding channel 112. Moreover, the end cap 30 has three guiding grooves 31, and each one of the three guiding grooves 31 is aligned with the guiding channel 112 of a respective one of the three engaging grooves 111 and communicates with the guiding channel 112.

With reference to FIGS. 1 to 3, the cutter 40 is inserted through the end cap 30, extends into the chamber 11 of the cutter holder 10, and has a keyway 41 formed on an outer surface of the cutter 40.

With reference to FIGS. 1 to 3, the positioning key 50 is detachably mounted in the keyway 41 of the cutter 40 and has a body 51 and a protruding rod 52. The body 51 is mounted in the keyway 41 of the cutter 40. The protruding rod 52 protrudes from one of two sides of the body 51 away from the keyway 41 and is capable of extending into the guiding channel 112 and the limiting groove 113 of the at least one engaging groove 111, such that the positioning key 50 is limited in the limiting groove 113 of the at least one engaging groove 111 of the cutter holder 10 along with the cutter 40. In another embodiment, the positioning key 50 may be disposed in the keyway 41 of the cutter 40 integrally.

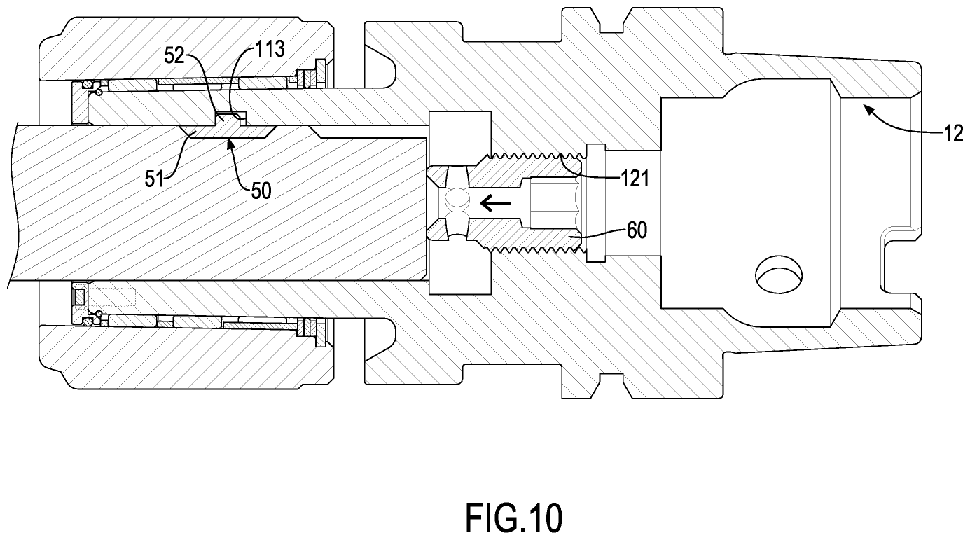

With reference to FIGS. 1, 3, and 4, the compressing element 60 extends into the cutter holder 10 via the mounting groove 12, is mounted to the mounting hole 121 of the mounting groove 12, and is capable of moving relative to the mounting hole 121 along the axial direction of the cutter holder 10. With reference to FIGS. 1 and 10, in such an arrangement, the compressing element 60 can abut against one of two ends of the cutter 40 extending into the chamber 11 of the cutter holder 10 to tightly compress the protruding rod 52 of the positioning key 50 in the limiting groove 113 of the at least one engaging groove 111, which lowers the degree of vibration of the cutter 40 relative to the cutter holder 10 during a machining process. Furthermore, the compressing element 60 has a thread disposed on an outer surface of the compressing element 60, such that the compressing element 60 is capable of moving relative to the mounting hole 121 along the axial direction of the cutter holder 10 by being threaded to the mounting hole 121.

With reference to FIGS. 1 to 3, the nut 70 is sleeved on the needle roller bearing 20 and surrounds the chamber 11. That is, the needle roller bearing 20 is disposed between the cutter holder 10 and the nut 70. Moreover, the nut 70 can be sleeved on the cutter holder 10 without having the needle roller bearing 20 disposed between the cutter holder 10 and the nut 70.

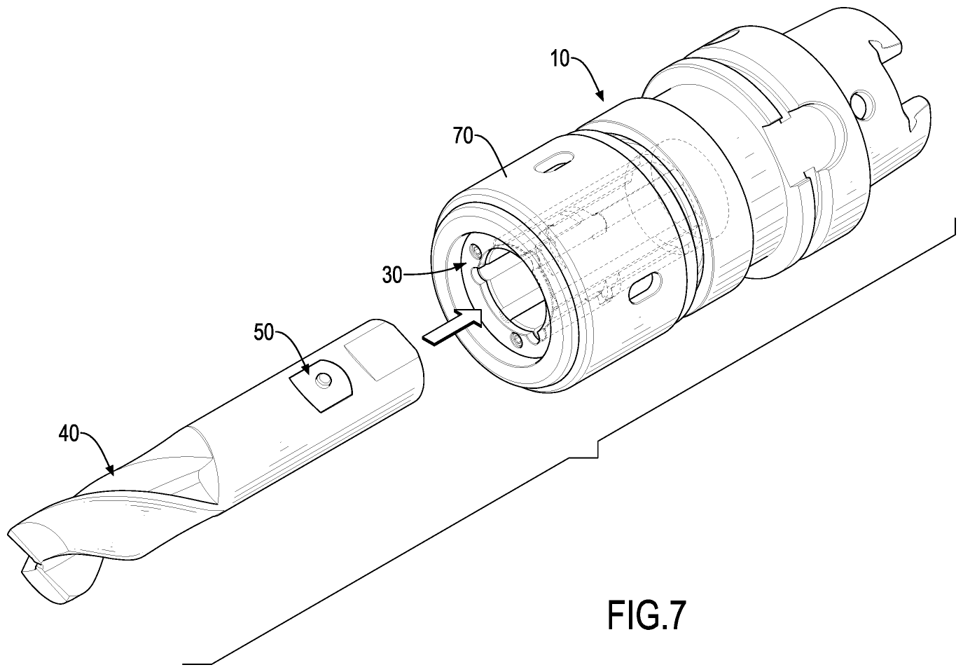

With reference to FIGS. 2, 7, and 8, to assemble the cutter holder assembly capable of preventing a cutter thereof from falling in accordance with the present invention, mount the needle roller bearing 20, the end cap 30, the compressing element 60, and the nut 70 to the cutter holder 10 firstly. Next, place the positioning key 50 on the keyway 41 of the cutter 40, and then align the protruding rod 52 of the positioning key 50 with the at least one guiding groove 31 of the end cap 30 to extend the cutter 40 into the chamber 11 of the cutter holder 10 via the end cap 30 along with the positioning key 50. In the process of extending the cutter 40 into the chamber 11 of the cutter holder 10, the protruding rod 52 of the positioning key 50 is guided by the at least one guiding groove 31 of the end cap 30 and the guiding channel 112 of the at least one engaging groove 111 communicating with the at least one guiding groove 31 sequentially until one of the two ends of the cutter 40 extending into the chamber 11 abuts against the compressing element 60.

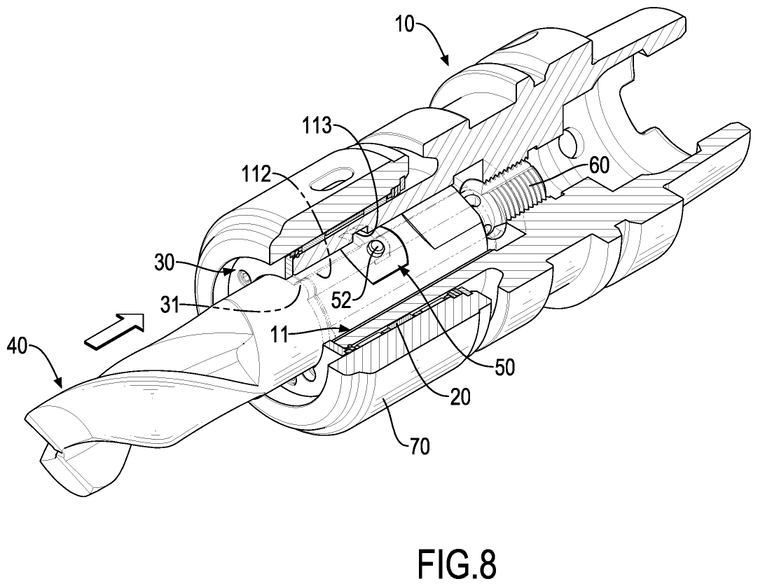

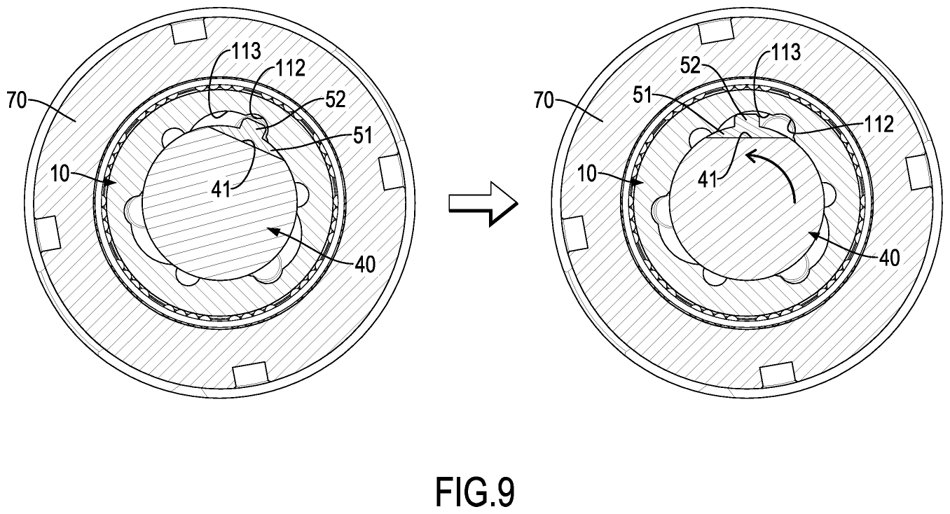

With reference to FIGS. 8 and 9, then, rotate the cutter 40 and make the positioning key 50 rotate along with the cutter 40, such that the protruding rod 52 of the positioning key 50 extends into the limiting groove 113 of the at least one engaging groove 111. In such a manner, the cutter 40 can be assembled with the cutter holder 10 via the positioning key 50. With reference to FIGS. 8 and 10, after the cutter 40 is assembled with the cutter holder 10, a gap exists between the protruding rod 52 of the positioning key 50 and the limiting groove 113 of the at least one engaging groove 111, which leads to the vibration of the cutter 40 relative to the cutter holder 10 in a machining process.

To prevent this circumstance, a user can extend a screwdriver into the mounting groove 12 of the cutter holder 10 to mount the screwdriver to the compressing element 60. Then, rotate the screwdriver to make the compressing element 60 rotate along with the screwdriver and mounted to the mounting hole 121 of the mounting groove 12. In the process of the compressing element 60 threaded to the mounting hole 121 of the mounting groove 12, the compressing element 60 moves relative to the mounting hole 121 and compresses the cutter 40 toward a direction away from the mounting groove 12, such that the protruding rod 52 of the positioning key 50 is tightly compressed in the limiting groove 113 of the at least one engaging groove 111.

With the aforementioned technical characteristics, the cutter holder assembly capable of preventing a cutter thereof from falling in accordance with the present invention has the following advantages.

1. After the protruding rod 52 of the positioning key 50 is aligned with the at least one guiding groove 31 of the end cap 30, the user only needs to extend the cutter 40 into the at least one guiding groove 31 of the end cap 30 and the guiding channel 112 of the at least one engaging groove 111 communicating with the at least one guiding groove 31 until the cutter 40 abuts against the compressing element 60 and rotate the cutter 40 to make the protruding rod 52 of the positioning key 50 extend into the limiting groove 113 of the at least one engaging groove 111 to assemble the cutter 40 with the cutter holder 10. Since the at least one guiding groove 31 of the end cap 30 and the guiding channel 112 of the at least one engaging groove 111 of the cutter holder 10 provide the positioning key 50 with guiding effects, the cutter holder assembly capable of preventing a cutter thereof from falling can be easily assembled and saves time in the assembling process. Compared with the conventional cutter holder assembly capable of preventing a cutter thereof from falling that should be assembled by rotating the cutter repeatedly to align the compression groove of the cutter with the mounting groove of the side lock holder, the cutter holder assembly capable of preventing a cutter thereof from falling in accordance with the present invention provides ease and time efficiency in assembly.

2. Since the protruding rod 52 of the positioning key 50 is guided by the at least one guiding groove 31 of the end cap 30 and the guiding channel 112 of the at least one engaging groove 111 of the cutter holder 10 during the assembling process, the positioning key 50 will not fall from the cutter holder 10.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A cutter holder assembly comprising:
a cutter holder having
a chamber formed in the cutter holder and having
at least one engaging groove formed on an inner surface of the chamber and having
a guiding channel formed on the inner surface of the chamber and having a longitudinal direction; and
a limiting groove formed on the inner surface of the chamber, communicating with the guiding channel, and having a longitudinal direction;
wherein an included angle is formed between the longitudinal direction of the limiting groove and the longitudinal direction of the guiding channel; and
a mounting hole formed in the cutter holder and communicating with the chamber of the cutter holder;
an end cap mounted on one of two end surfaces of the cutter holder adjacent to the chamber and having
at least one guiding groove formed on an inner surface of the end cap, aligned with the guiding channel of the at least one engaging groove of the cutter holder, and communicating with the guiding channel;
a cutter inserted through the end cap, extending into the chamber of the cutter holder, and having a keyway formed on an outer surface of the cutter;
a positioning key mounted in the keyway of the cutter and having
a body mounted in the keyway of the cutter; and
a protruding rod protruding from one of two sides of the body away from the keyway of the cutter and being capable of extending into the guiding channel and the limiting groove of the at least one engaging groove, such that the positioning key is limited in the cutter holder along with the cutter;
a compressing element mounted to the mounting hole of the cutter holder, and being capable of moving relative to the mounting hole along an axial direction of the cutter holder, such that the compressing element abuts against one of two ends of the cutter inserted into the chamber of the cutter holder to tightly compress the protruding rod of the positioning key in the limiting groove of the at least one engaging groove; and
a nut sleeved on the cutter holder and surrounding the chamber of the cutter holder;
wherein the positioning key is limited in the limiting groove of the at least one engaging groove of the cutter holder after the protruding rod of the positioning key is guided into the guiding channel and the limiting groove of the at least one engaging groove sequentially.

2. The cutter holder assembly as claimed in claim 1, wherein the chamber has three said engaging grooves arranged on the inner surface of the chamber at spaced intervals.

3. The cutter holder assembly as claimed in claim 1, wherein the cutter holder assembly has a needle roller bearing sleeved on an outer surface of the cutter holder, surrounding the chamber of the cutter holder, and disposed between the cutter holder and the nut.

4. The cutter holder assembly as claimed in claim 2, wherein the cutter holder assembly has a needle roller bearing sleeved on an outer surface of the cutter holder, surrounding the chamber of the cutter holder, and disposed between the cutter holder and the nut.

5. The cutter holder assembly as claimed in claim 1, wherein the compressing element is threaded to the mounting hole of the cutter holder.

6. The cutter holder assembly as claimed in claim 2, wherein the compressing element is threaded to the mounting hole of the cutter holder.

7. The cutter holder assembly as claimed in claim 3, wherein the compressing element is threaded to the mounting hole of the cutter holder.

8. The cutter holder assembly as claimed in claim 4, wherein the compressing element is threaded to the mounting hole of the cutter holder.
